(19) United States
(12) Patent Application Publication
(10) Pub. No.: US 2018/0365082 A1
(43) Pub. Date: Dec. 20, 2018

(54) COMMUNICATING BETWEEN APPLICATIONS, RUNNING ON DIFFERENT NODES, HAVING LOGIC IN DIFFERING LANGUAGES

(71) Applicant: OpenIOLabs Ltd, Cambridge, Cambridgeshire (GB)

(72) Inventor: Andrew J. Richardson, Cambridge (GB)

(21) Appl. No.: 15/771,463

(22) PCT Filed: Oct. 27, 2016
(86) PCT No.: PCT/GB2016/053342

§ 371 Date: Apr. 27, 2018

(30) Foreign Application Priority Data
Oct. 27, 2015 (GB) 1518949.1
Mar. 4, 2016 (GB) 1603814.3

(51) Int. Cl. G06F 9/54; G06F 8/41; G06F 8/51

(52) U.S. Cl. CPC G06F 9/541; G06F 8/42; G06F 8/51; G06F 8/47; G06F 8/447

(57) ABSTRACT

Aspects of the invention relate to methods of communicating between an originating application running on an originating node and a destination application miming on a destination node, wherein application logic of the originating and destination applications is respectively in differing originating and destination languages. Further aspects relate to originating nodes, destination nodes and communication systems comprising such nodes, as well as data packets for such communication. In particular, one method comprises the originating node encoding a block of application logic of the originating application into one or more language interface tokens to be transmitted to the destination node, wherein the language interface tokens are configured to be decoded by the destination node for execution by the destination application.

The present disclosure relates to methods and systems for communicating between nodes such that application logic of an application running on one node can be executed by an application running on the other node, when application logic of the two applications is in differing languages.

More specifically, aspects relate to methods of communicating between an originating application running on an originating node and a destination application running on a destination node, wherein application logic of the originating and destination applications is respectively in differing originating and destination languages. Further aspects relate to originating nodes, destination nodes and communication systems comprising such nodes, as well as data packets for such communication.

The phrase “application logic” will be used herein to mean, at a level above a specific language, what is intended to be implemented by that language. As an example in C:

integerOutputVariable = integerInputvariable1 +
integerInputVariable2;

The application logic in this case is to take two integer variables (for brevity, we have omitted to define word sizes for the integers), sum the two integers together and assign the result to a third integer.

As processing and communication functionality becomes available in ever smaller form factors, an increasing number of devices are being equipped with such functionality. Many devices are now available in “smart” and/or “connected” variants, leading to a web of technology known as “the internet of things” (IoT) being present in a variety of settings including homes, public spaces such as retail centres, offices, laboratories and factories.

What is needed to accompany these developments are improved methods of interfacing connected devices to one another. For example, such methods could be deployed in machine-to-machine heterogeneous networks (M2M-Het-Nets).

According to a first aspect, there is provided a method of communicating between an originating application running on an originating node and a destination application running on a destination node, wherein application logic of the originating and destination applications is respectively in differing originating and destination languages, the method comprising: the originating node encoding a block of application logic of the originating application into one or more language interface tokens to be transmitted to the destination node, wherein the language interface tokens are configured to be decoded by the destination node for execution by the destination application.

The method could further comprise the originating node transmitting the language interface tokens to the destination node.

The method could further comprise a decoder of the destination node decoding the language interface tokens.

The method could further comprise the destination application executing an output of the decoder.

The encoding could comprise a scanner converting the block of application logic of the originating application into one or more interim tokens and/or literals. The encoding could further comprise the scanner passing the one or more interim tokens and/or literals to a parser. The encoding could further comprise the parser converting the one or more tokens and/or literals into the one or more language interface tokens.

The scanner could be written in Flex. The parser could implement syntactical analysis using GNU Bison. The grammar of the parser could be defined in terms of a modified Backus-Naur form (BNF).

A set of interim tokens common to all supported originating languages could be input to the scanner. A set of language specific interim tokens, specific to the language of the originating application, could be input to the scanner. Grammar common to all supported originating languages could be input to the parser. Language specific grammar, specific to the language of the originating application, could be input to the parser.

The method could further comprise the originating node preparing the language interface tokens for transport in the form of a serialised parse tree. Alternatively, the method could further comprise the originating node preparing the language interface tokens for transport as a pseudo code representation of a parse tree from which the parse tree can be reconstructed.

In addition to the serialised parse tree or the pseudo code representation of the parse tree, the language interface tokens could comprise additional logic not derived directly from parsing.

The additional logic could comprise one or more of: special language features, decoder capability requirements and language extensions.

Transmission of the language interface tokens to the destination node could be done via a relay node.

The encoding could comprise encoding of address data for the destination node.

The method could further comprise the originating node encoding an additional block of application logic of the originating application into one or more additional language interface tokens to be transmitted to an additional node. The additional language interface tokens could be configured to be decoded by the additional node and executed by an additional application running on the additional node according to application logic in an additional language. The encoding of the additional block of application logic could comprise encoding of address data for the additional node.

The block of application logic could be to initialise and/or control and/or monitor the destination node.

The method could further comprise the originating node storing capability data relating to the destination node.

The encoding could comprise determining, using the capability data, that the block of application logic comprises a function or procedure supported by an accelerator of the destination node. The encoding could further comprise encoding that function or procedure by copying its expression in the originating language and adding an accelerator flag to indicate to the destination node that the function should be executed directly by the accelerator, without decoding.

The accelerator could be a hardware accelerator or a software accelerator.

The language interface tokens could be configured to represent one or more of: definitions of variables, flow control statements, loops, case and switch statements, accelerator functions, get and set primitives, mathematical functions, and timer and wait functions.

The language interface tokens could be in one of: a type-length-value (TLV) format, a pure binary format, a JavaScript Object Notation (JSON) format, an Extensible Markup Language (XML) format and a protocol buffer format.

The encoding could comprise defining additional language interface tokens. The encoding could further comprise encoding the additional language interface tokens together with an extension token flag.

Application logic of the originating application could be in a plurality of originating languages, the block of application logic comprising a plurality of functions and/or support libraries and/or method calls respectively coded in a plurality of said plurality of originating languages.

According to a second aspect there is provided an originating node comprising: memory configured to store application logic for an originating application in an originating language; and a processor configured to encode a block of the application logic in the originating language into one or more language interface tokens to be transmitted to a destination node, wherein the language interface tokens are configured to be decoded for execution by an application running on the destination node according to application logic in a destination language.

According to a third aspect there is provided a method of communicating between an originating application running on an originating node and a destination application running on a destination node, wherein application logic of the originating and destination applications is respectively in differing originating and destination languages, the method comprising: the destination node decoding one or more language interface tokens for execution by the destination application, the language interface tokens having been received from the originating node which encoded them from a block of application logic in the originating language.

The decoding could comprise converting a received serialised parse tree comprising the one or more language interface tokens into a decoded parse tree.

The decoding could comprise a scanner converting received pseudo code comprising the one or more language interface tokens into one or more interim tokens and/or literals. The decoding could further comprise the scanner passing the one or more interim tokens and/or literals to a parser. The encoding could further comprise the parser converting the one or more interim tokens and/or literals into a decoded parse tree.

The scanner could be written in Flex. The parser could implement syntactical analysis using GNU Bison. The grammar of the parser could be defined in terms of a modified Backus-Naur form (BNF).

A set of interim tokens common to all supported destination languages could be input to the scanner. A set of language specific interim tokens, specific to the destination language of the destination application, could be input to the scanner. Grammar common to all supported destination languages could be input to the parser. Language specific grammar, specific to the destination language of the destination application, could be input to the parser.

The decoding could comprise inputting the decoded parse tree to a translator. The decoding could further comprise inputting an output of the translator to a compiler.

The method could further comprise passing the decoded parse tree to an interpreter of the destination application for execution.

According to a fourth aspect there is provided a destination node comprising:

memory configured to store application logic for a destination application in a destination language; and a processor configured to decode one or more language interface tokens for execution by the destination application, the language interface tokens having been received from an originating node which encoded them from a block of application logic of an originating application in an originating language which differs from the destination language.

The destination node could comprise one or more of: a sensor (such as a temperature or humidity sensor or an accelerometer), a motor, a heater, a light (e.g. a light emitting diode, LED), an actuator, a user interface device (e.g. a touchscreen, keyboard, mouse, joystick, microphone, camera, display screen, speaker or haptic feedback device), an analogue to digital converter (ADC), a digital to analogue converter (DAC), a switch (e.g. a relay), a memory (e.g. storing a data set and/or database) and an application programming interface (API).

According to a fifth aspect there is provided a method of communicating between an originating application running on an originating node and a destination application running on a destination node, wherein application logic of the originating and destination applications is respectively in differing originating and destination languages, the method comprising: the originating node encoding a block of application logic of the originating application into one or more language interface tokens; the originating node transmitting the language interface tokens to the destination node; the destination node receiving the language interface tokens; the destination node decoding the language interface tokens for execution by the destination application; and the destination application executing the decoded language interface tokens.

According to a sixth aspect there is provided a communication system comprising an originating node and a destination node, the originating node comprising: memory configured to store application logic for an originating application in an originating language; and a processor configured to encode a block of the application logic in the originating language into one or more language interface tokens to be transmitted to the destination node; and the destination node comprising: memory configured to store application logic for a destination application in a destination language; and a processor configured to decode the language interface tokens for execution by the destination application.

The communication system could further comprise a relay node configured to route language interface tokens received from the originating node to the destination node.

According to a seventh aspect there is provided a method of communicating between an originating application running on an originating node and a destination application running on a destination node, comprising the methods of the first and third aspects.

According to an eighth aspect there is provided a communication system comprising the originating node of the second aspect and one or more of the destination nodes of the fourth aspect.

According to a ninth aspect there is provided a data packet for transmission from an originating node to a destination node, comprising one or more language interface tokens which: encode a block of application logic of an originating application running on the originating node; and are configured to be decoded for execution by a destination application running on the destination node according to application logic in a destination language; wherein the originating and destination languages differ.

According to a tenth aspect there is provided a method substantially as herein described, with reference to the accompanying figures.

According to an eleventh aspect there is provided an originating node substantially as herein described, with reference to the accompanying figures.

According to a twelfth aspect there is provided a destination node substantially as herein described, with reference to the accompanying figures.

According to a thirteenth aspect there is provided a communication system substantially as herein described, with reference to the accompanying figures.

According to a fourteenth aspect there is provided a data packet substantially as herein described, with reference to the accompanying figures.

Aspects of the present invention will now be described by way of example with reference to the accompanying figures. In the figures:

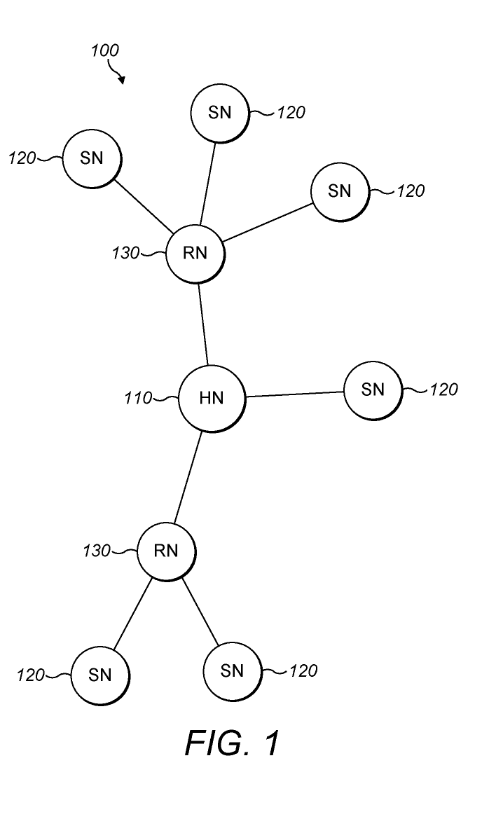

FIG. 1 schematically illustrates an example communication system;

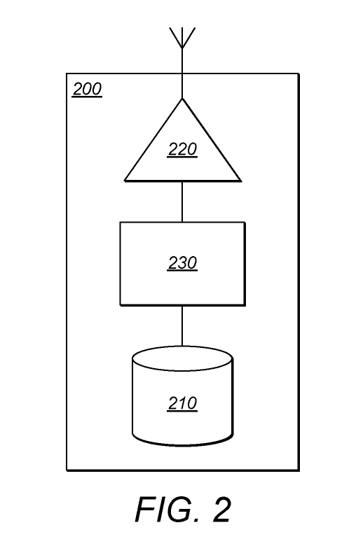

FIG. 2 schematically illustrates a generic node;

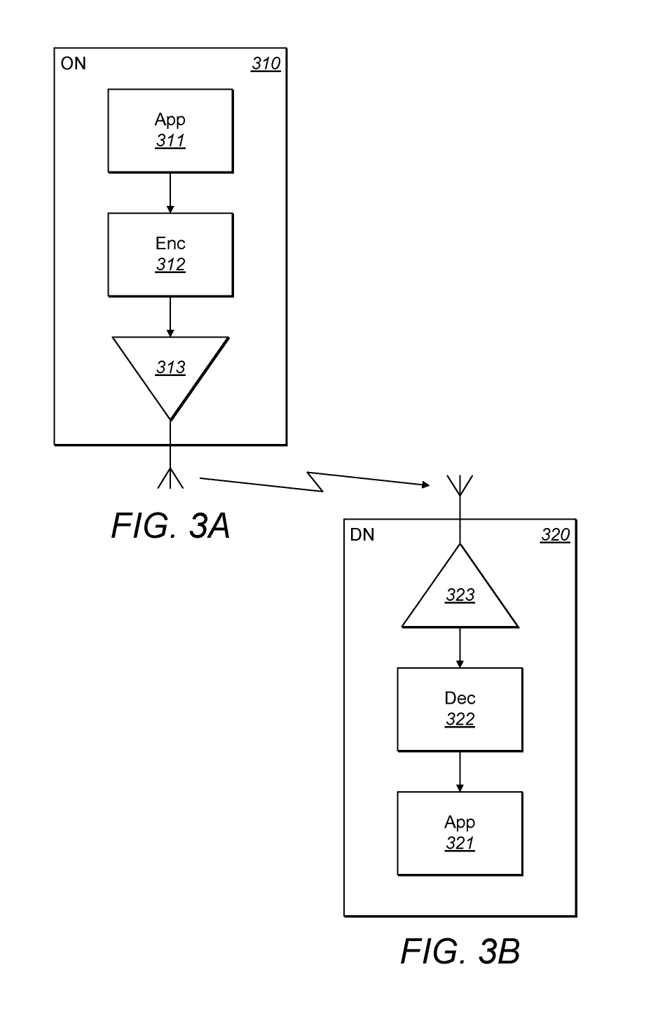

FIG. 3A schematically illustrates functional modules of an originating node;

FIG. 3B schematically illustrates functional modules of a destination node;

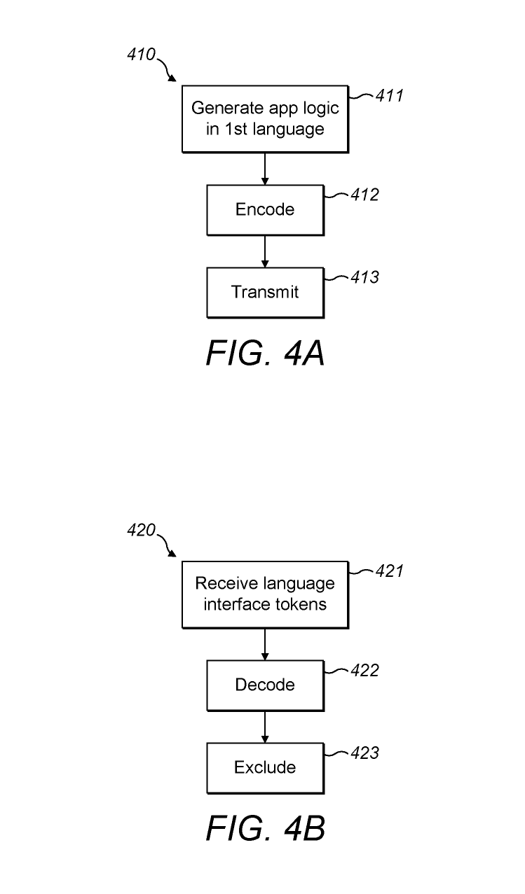

FIG. 4A is a flow chart of an example method performed by an originating node;

FIG. 4B is a flow chart of an example method performed by a destination node;

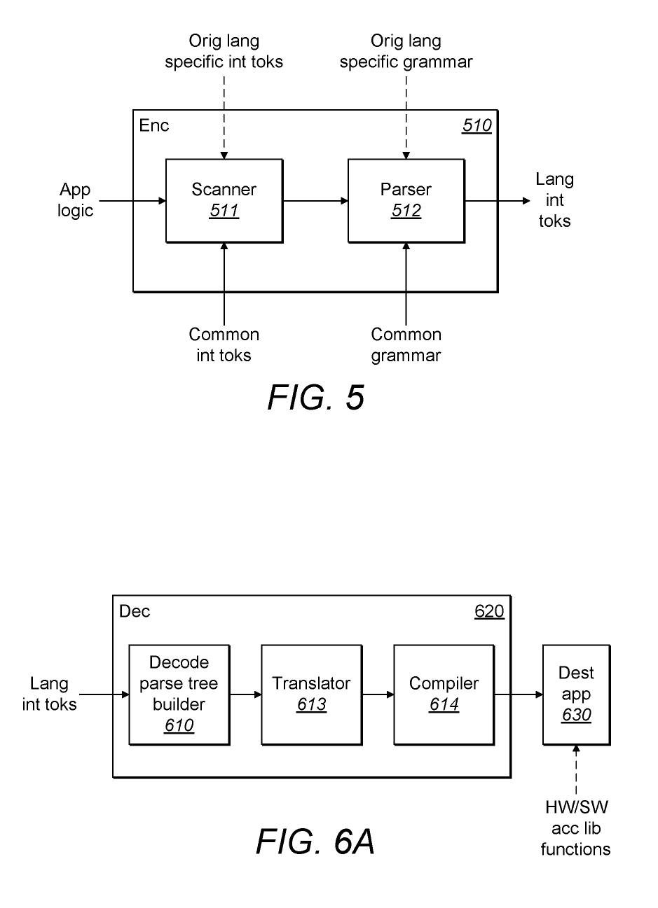

FIG. 5 illustrates operation of an example encoder;

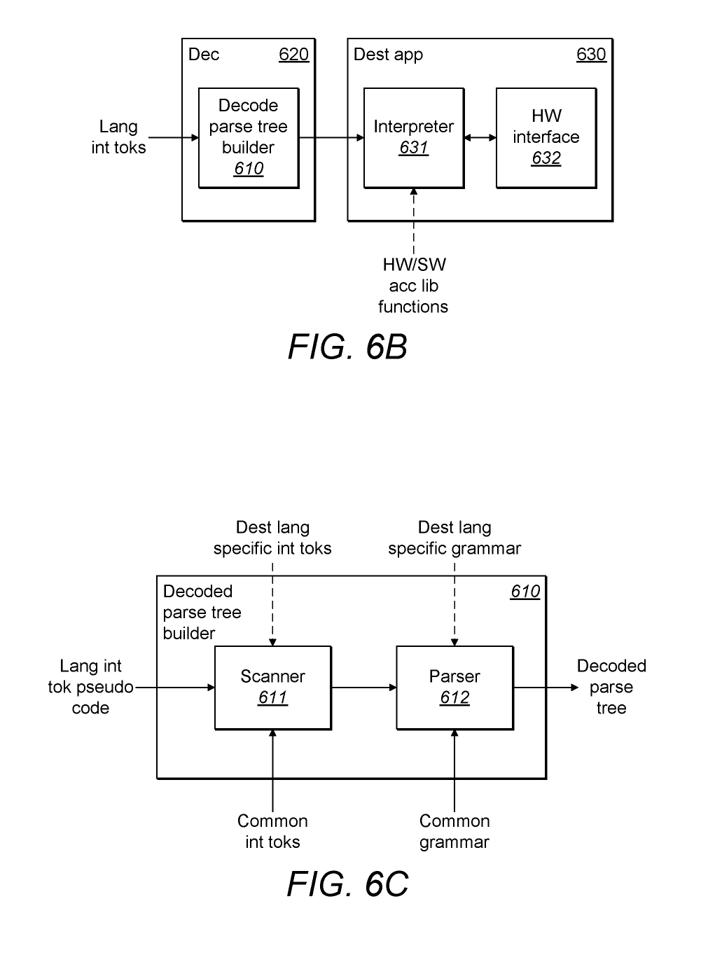

FIG. 6A illustrates an example implementation for decoding and executing the language interface tokens at the destination node;

FIG. 6B illustrates another example implementation for decoding and executing the language interface tokens at the destination node;

FIG. 6C illustrates the operation of an example decoded parse tree builder;

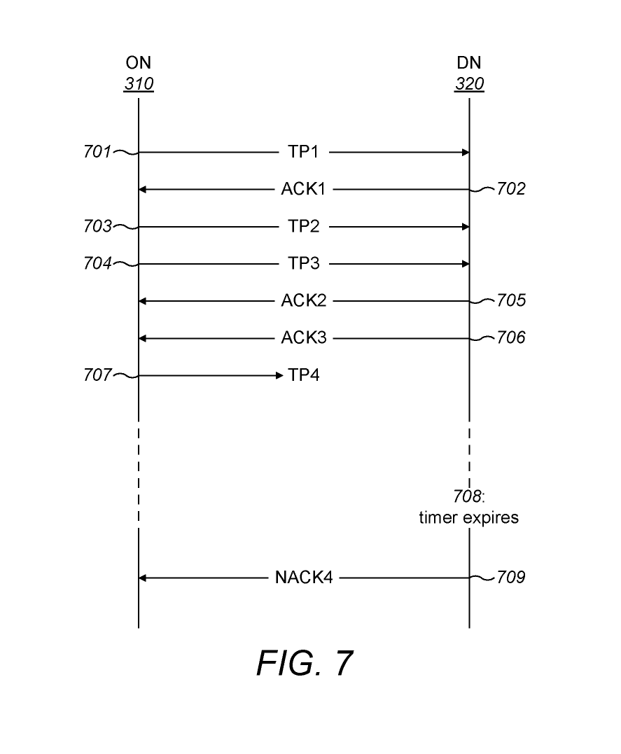

FIG. 7 illustrates an example message flow such as might occur between an originating node and destination node;

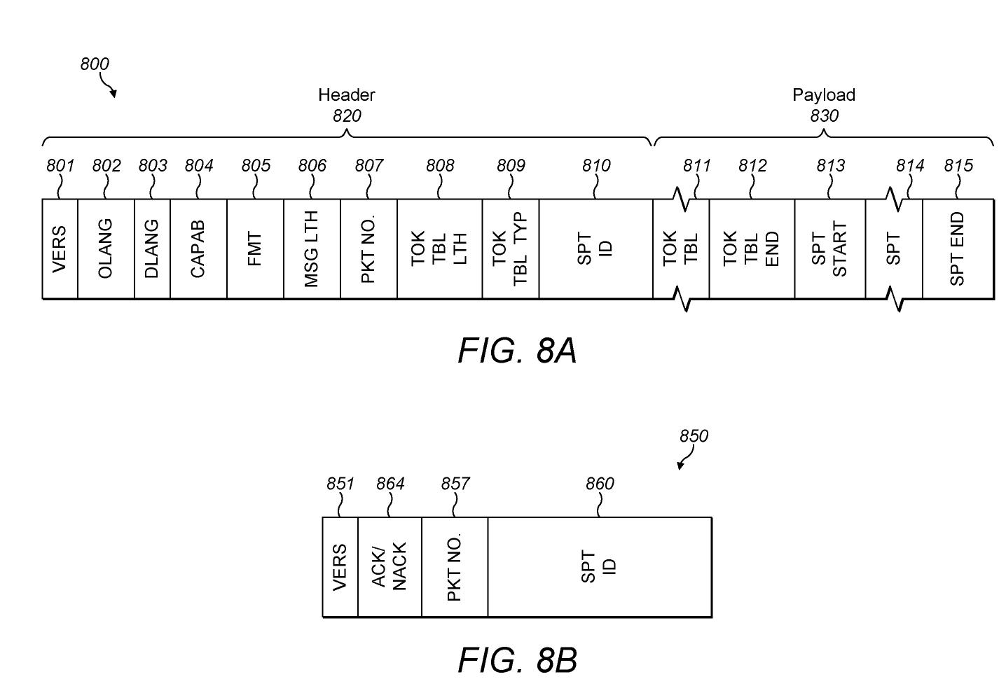

FIG. 8A illustrates the structure of an example transport packet; and

FIG. 8B illustrates the structure of an example ACK/NACK packet.

The following description is presented to enable any person skilled in the art to make and use the system, and is provided in the context of a particular application. Various modifications to the disclosed embodiments will be readily apparent to those skilled in the art.

The present inventor has recognised a problem with the emergence of the IoT that, as various manufacturers seek to upgrade their products to smart/connected versions, the new functionality is provided through many different commercial, open source and proprietary applications. If the relevant application logic is coded in different languages, it may not be possible to communicate effectively between devices.

This is a particular problem in industrial or academic settings such as laboratories and factories. In such environments proprietary code often needs to be developed for controlling and/or monitoring and/or retrieving data from a disparate range of equipment. Hardware and software for such equipment can originate from a variety of sources who may favour a corresponding variety of languages for their application logic. The staff available to write the proprietary code may know and/or favour only a limited number of programming languages, which will not necessarily match those in which application logic for the devices to be controlled and/or monitored is coded.

To solve these problems, a method of interfacing between connected nodes is provided. An originating application running on an originating node has application logic coded in an originating language. The originating node encodes a block of application logic into one or more language interface tokens. The tokens are then transmitted to a destination node. The destination node decodes the tokens for execution by a destination application running on the destination node according to application logic in a destination language. In this manner, the originating node can convey messages to the destination node to allow communication between the originating and destination applications, even though they are not coded in the same language. These messages may for example enable automatic control and/or monitoring and/or data retrieval.

The language interface tokens provide a common framework for representing the meaning of blocks of application logic, independent of the syntax of the programming language in which they are originally coded. For example, language interface tokens can be configured to represent one or more of: assignments such as definitions of variables, flow control statements, loops, case and switch statements, accelerator functions, get and set primitives, mathematical functions, timer and wait functions and other functions and procedures common to e.g. ALGOL, Ada, BASIC, C, C++, C#, Fortran, Go, Haskell, Java, JavaScript, LabVIEW, Mathematica, Matlab, Objective-C, Octave, Pascal, Pearl, PHP, Python, Ruby, Tcl, Visual Basic and similar languages. In other words, the language interface tokens define a representation of application logic common to all supported originating and destination application languages.

A stream of language interface tokens are used to define the application logic that was created from the originating language and implemented in the destination logic. The tokens define the capabilities of an underlying “meta language”.

The operations of (i) encoding application logic in an originating language into language interface tokens; and (ii) decoding language interface tokens into a destination language are in some ways similar to translations. However, the language interface tokens do not constitute elements of a language as such, they rather provide a language template that allows the logic and flow of an application defined in one domain to be transferred to and operate in another domain. The operations of (i) encoding followed by (ii) decoding as set out above together have the effect of translating application logic from an originating language to a destination language.

As an analogy, the language interface tokens are like start and end points marked on a map, and the destination node is configured to, on receiving the language interface tokens, determine directions for an appropriate route between those points depending on the mode of transport (destination language) available at the destination node. For example, the details of the route might differ depending on whether we travel by car (assembler language), bicycle (C) or walking (Python).

The originating node could for example be a user device such as a personal computer (PC), laptop, tablet or smartphone used to control one or more connected devices (destination nodes) such as sensors, motors, heaters, lights, actuators, user interface devices, switches, communication devices and data storage devices, or vice-versa.

The system architecture could for example be based on the oneM2M architecture. (oneM2M is the global standards initiative for machine-to-machine communications and the IoT.)

FIG. 1 schematically illustrates an example communication system 100. A hub node (HN) 110 is connected by communication channels (which could be wired or wireless) to one or more remote spoke nodes (SNs) 120. This connection can be direct or via one or more relay nodes (RNs) 130. Each communication channel can be, for example, any one of a WiFi, Bluetooth™, near field communication (NFC), cellular network, Ethernet, universal serial bus (USB), optical fibre or telephone line channel, amongst others. The communication functionality used could pre-exist in the nodes, or could be added to them by retrofitting them with communication modules. Where multiple spoke nodes and/or one or more relay nodes are present, the various communication channels need not be of the same type. Depending on the direction of communication, the hub node may be an originating node as described above and the spoke nodes destination nodes, or vice-versa. The hub and spoke nodes may simultaneously act as both originating and destination nodes.

Nodes 110, 120, 130 may each comprise a single device, or a plurality of devices configured to communicate with one another.

For example, hub node 110 could comprise a portable user device such as a smartphone, in communication with a server computer, e.g. via a cellular communication network. The user device could comprise one or more user interface devices to enable a user to interact with applications stored thereon. Onerous processing and/or storage tasks could however be offloaded to the server computer to save on usage of limited battery and processing power and memory space of the user device. This could for example be done via an application programming interface (API).

Similarly, spoke nodes 120 could each comprise one or multiple devices. For example, a spoke node could comprise a legacy device adapted for operation according to the methods disclosed herein by connection to an add-on module, for example via a RS232 (radio Sector 232), I²C (inter-integrated circuit), SPI (serial peripheral interface), GPIO (general purpose input/output) or USB port. (Legacy devices could alternatively be adapted for such operation by running appropriate software or firmware thereon.) Such an add-on module could comprise an input and/or output interface (IOI) for interfacing between one or more of the communication channels referred to above and the in-built functions of the legacy device, which could for example comprise one or more sensors, motors, heaters, lights, actuators, user interface devices, switches, communication devices or data storage devices. Alternatively or additionally, the add-on module could provide a language interface encoder and/or decoder.

Such an encoder and/or decoder could be used for adaptation of an already “connected” device (i.e. a device comprising communication apparatus).

FIG. 2 schematically illustrates a generic node 200, which could be a hub node, a spoke node or a relay node. Generic node 200 comprises a memory 210 and communication apparatus 220, each operatively coupled to a processor 230. Memory 210 may comprise one or more memories in the same or distributed locations and of the same or various types. Similarly, processor 220 may comprise one or more processors in the same or distributed locations and of the same or various types. Thus, node 200 may comprise one or a plurality of devices configured to communicate with one another. Communication apparatus 220 comprises one or more receivers, transmitters or transceivers for communication with another node.

FIG. 3A schematically illustrates functional modules of an originating node (ON) 310. Application 311 is configured to generate a block of application logic in an originating language and pass this to language interface encoder 312. The encoder 312 is configured to encode the block of application logic in the originating language into one or more language interface tokens suitable for transmission to a destination node over one or more communication channels connecting the originating and destination nodes. The encoder 312 is configured to pass the language interface tokens to transmitter 313. Transmitter 313 is configured to transmit the language interface tokens to the destination node.

Encoder 312 is specific to the application language used by application 311, but the language interface tokens produced by it should be the same irrespective of the language used by the target application at the destination node.

FIG. 3B schematically illustrates functional modules of a destination node (DN) 320. Receiver 323 is configured to receive one or more language interface tokens from an originating node and pass these to language interface decoder 322. The decoder 322 is configured to decode the language interface tokens for execution by application 321.

Two-way communication can be enabled by incorporating the functional modules of both originating node 310 and destination node 320 in a single node, for example a hub node or a spoke node as described in relation to FIG. 1 above. In such a case, some hardware elements could perform dual functions. For example, a transceiver could act as both transmitter 313 and receiver 323. A single processor could run code to provide the functionalities of some or all of encoder 312, decoder 322, application 311 and application 321 and/or a single memory could store such code and associated data.

FIG. 4A is a flow chart of an example method 410 performed by an originating node such as ON 310. At 411 a block of application logic is generated in an originating language. At 412 this is encoded into one or more language interface tokens suitable for transmission to a destination node over one or more communication channels connecting the originating and destination nodes. At 413 the language interface tokens are transmitted to the destination node.

Encoding the application logic can comprise encoding address data for the destination node. This is useful if the channel used to communicate between the originating and destination nodes is accessible by any third parties and/or if messages are routed through a relay node. Such address data could comprise identification data for a particular destination node, and/or data identifying its location.

The originating node might generate a master script comprising several child scripts, each intended for a different destination node. The master script could be transmitted to a relay node which separates out the child scripts and routes them to the appropriate destination nodes.

The transmission itself could for example be according to a protocol such as user datagram protocol (UDP), transmission control protocol (TCP) or similar.

FIG. 4B is a flow chart of an example method 420 performed by a destination node such as DN 320. At 421 one or more language interface tokens are received from an originating node. At 422 they are decoded for execution by a destination application at 423.

In some examples, the encoding scheme could group together language features in a number of classes. This serves to constrain the complexity of the language to simplify the implementation code foot print on the destination node. For example, five language feature classes could be defined as follows.

| Language Feature | |
|---|---|
| Class | Example Language Features |
| 1 | Integer variables expressions |
| | Loops |
| | Conditional logic |
| | Switch-like statements |
| 2 | Functions |
| | Floating point variable expressions |
| | String expressions |
| 3 | Simple Object Oriented Programming (OOP) |
| | support |
| | Structures, unions and typedefs |
| 4 | Complex OOP support |
| | Graphics support |
| 5 | Mathematical library support |
| | Advanced OOP functions and library support |

While the language interface token encoding scheme makes it possible to “translate” application logic for most basic functions and procedures, there may be some functions or procedures not covered by the scheme for some pairings of originating and destination languages. Some of the language features may either be irrelevant to a specific language, or not implementable.

For example, certain more complex functions such as fast Fourier transforms (FFTs), image compression functions or statistical analysis functions might not be covered. However, the destination node can be provided with means to carry out such functions in the form of a hardware or software accelerator.

For example, a hardware accelerator could be provided by connecting a field-programmable gate array (FPGA), application-specific integrated circuit (ASIC), graphics processing unit (GPU) or single-board computer to the destination node's main microcontroller. The hardware accelerator could be interfaced to the rest of the destination node in a manner that appears as a function call to the node.

The part of the application logic not covered by the language interface token encoding scheme could then be encoded by copying it, as is in the originating language, in to the message stream, but flagging it to the decoder as a block to be passed to the accelerator for execution as is. In some circumstances, even if the language interface token encoding scheme does cover the required function or procedure, if accelerator functionality is available at the destination node it may be more efficient, in terms of time and processing power, to use this technique.

Software accelerators could act as functions that exist outside of the originating language but are resident within the destination node software as e.g. linked library files, or as hard-coded into the node firmware. As for hardware accelerators, software accelerators could be interfaced to the rest of the destination node in a manner that appears as function calls to the node. Software accelerators could for example be used to calculate a running average of a sequence of collected data, or find the maximum or minimum of a set of data.

The language interface tokens should be chosen so as to have an unambiguous meaning. They should be the same for all originating languages and all spoken languages. The tokens should be brief to minimise the transmission resource required to transport them through the system. They could for example be defined using the American Standard Code for Information Interchange (ASCII) bit character set.

The language interface tokens do not require a human readable representation, although viewers may be used to translate them into a human readable equivalent, for example as defined in the table below. This provides an example of a human readable language interface token keyword, an encoded token value, a mapping to a language feature class as discussed above and a description.

| | | Language | |
|---|---|---|---|
| | Numeric | Feature | |
| Token Keyword | Value | Class | Description |
| NUMBER | 258 | 1 | Defines an interim token to |
| | | | represent a number, in this |
| | | | case an integer |
| ADD | 259 | 1 | Defines an interim token to |
| | | | represent an addition |
| | | | operator |
| SUB | 260 | 1 | Defines an interim token to |
| | | | represent a subtraction |
| | | | operator |
| KEYWORDIF | 261 | 1 | The start of an IF statement |
| | | | (conditional) |
| KEYWORDELSE | 262 | 1 | Defines an interim token to |
| | | | represent the keyword else |
| | | | used in C programs |
| KEYWORDFOR | 263 | 1 | The start of a loop statement |
| KEYWORDSWITCH | 264 | 1 | The start of a switch/branch |
| | | | statement |
| KEYWORDINTEGER_8 | 265 | 1 | The definition of an 8-bit |
| | | | integer |
| KEYWORDFLOAT_32 | 266 | 2 | The definition of a 32 bit |
| | | | floating point number |
| KEYWORDFUNCTION | 267 | 2 | The start of a function |
| | | | definition |
| KEYWORDHW_{—} | 268 | 1 | A hardware accelerator |
| | | | function |
| KEYWORDSW_{—} | 269 | 1 | A software accelerator |
| | | | function |
| KEYWORDOBJECT | 270 | 3 | The start of an object- |
| | | | oriented programming (OOP) |
| | | | object definition |
| KEYWORDMATINV | 280 | 5 | An example of an advanced |
| | | | mathematical library function |
| | | | such as a matrix inverse |
| | | | operation |
| KEYWORDEXT | 32768 | | An extension token |

Regarding the final entry in the table above, it may be desirable to define an extension keyword token to allow for expansion of the token address space and to cover cases that require multiple meanings.

For example, the C for statement can specify the initialisation, test, and update operations of a structured loop in a single statement, e.g.:

for (init_exp; cond_exp; update_exp) loop_body_statement
init_exp is an expression that is evaluated before the loop is entered. The value of the expression is not used for anything; it is the expression's side effects that make init_exp useful. Typically, init_exp initialises a variable that is also used in the other expressions in the for statement. (Such a variable is often called a “loop control variable”.)
cond_exp is an expression that is evaluated before each pass through the loop. If the value of the expression is “false” (i.e., compares equal to zero) the loop is exited.
update_exp is an expression that is evaluated at the end of each pass through the loop, after the loop body has been executed, and just before looping back to evaluate cond_exp again. As with init_exp, this expression is only useful for its side effects; the value produced is thrown away. Typically, update_exp changes the value of a loop control variable.
loop_body_statement is any valid C statement or block.

All three of the expressions in brackets in the above for statement are optional. If cond_exp is omitted, the compiler treats it as always “true” (i.e., a constant non-zero value). If both init_exp and update_exp are omitted, the for statement is equivalent to a while statement. Since cond_expr is checked before every pass through the loop, including the initial pass, it is possible to exit the loop without ever executing loop_body_statement or update_exp.

An extension token could be used to indicate the presence of additional tokens that are specific to the problem being solved. In the for loop example, additional specific clauses could be defined indicating the absence of each of int_exp, cond_exp and update_exp.

FIG. 5 illustrates operation of an example encoder 510, such as may be used for encoder 312 of FIG. 3A. Encoder 510 comprises a scanner 511, e.g. written in Flex (an updated version of the Lex lexical analysis tool), and a parser 512, e.g. implementing syntactical analysis using parser generator GNU Bison. The scanner 511 takes a block of application logic in the originating language as input, and then outputs a stream of interim tokens and literals to the parser 512. The parser 512 then outputs the language interface tokens to be transmitted to the destination node.

The scanner 511 utilises a set of interim tokens that are common to all supported input languages. Some languages may however require additional interim tokens that are specific to that language to correctly interpret the application logic. Language specific interim tokens may also therefore need to be input to the scanner in some cases. The common interim tokens should be defined in such a way as to minimise the number of language specific interim tokens needed (ideally to nil), based on the set of languages supported at the time of definition. However, language specific interim tokens may need to be defined as the encoding scheme is expanded to support additional languages, for example in which the common interim tokens either give rise to ambiguity, or for which the common interim tokens cannot adequately capture the required application logic description.

The scanner is responsible for analysing the input application logic stream or script and identifying the presence of certain symbols that have been defined as part of the language interface token Meta language. The input symbols for the scanner will be different for each of the input languages; however the derived keywords will have a common basis as they will be used in the next step, the parser.

The scanner works through the originating language symbol stream with the intention of identifying specific sequences of symbols. Certain symbol sequences will correspond to special keywords or reserved symbol sequences. The scanner is configured to locate these special keywords and assign interim tokens to them. Examples of interim tokens with a numeric value are presented below:

NUMBER = 258, // Defines an interim token to represent a number, in
this case an integer
ADD = 259, // Defines an interim token to represent an addition
operator
SUB = 260, // Defines an interim token to represent a subtraction
operator
KEYWORDIF = 261, // Defines an interim token to represent the
keyword if as used in C programs
KEYWORDELSE = 262, // Defines an interim token to represent the
keyword else used in C programs

The scanner passes a stream of interim tokens and literals to the parser. The parser is responsible for the construction of the grammar for the output language interface tokens. The parser generator Bison could be used here. This is a derivative of “Yet Another Compiler Compiler” (YACC); a system which validates the grammar of a language based on an input grammar. The grammar could be defined in terms of a modified form of Backus-Naur Form (BNF), which is a syntax for describing syntax. BNF is used to write a formal representation of a context-free grammar. Bison (with BNF) can be used to define a series of statements, with these statements comprised of a sequence of expressions. At a high-level, the objective for Bison, within the context of the parser 512, is to take the sequence of tokens received from the scanner, and match the pattern of the tokens in a statement (and hence to all statements in the application program) to a specific form that is defined by the BNF grammar. The parser essentially validates that the input interim token stream is valid within the language structure/syntax that is defined by the BNF structure used as an input.

In an analogous manner to the scanner, it is recognised that future unforeseen languages may introduce syntax requirements that are either ambiguous or which cannot be readily implemented using the common grammar input to parser 512. Hence, on occasion, language specific grammar may need to be defined and input to parser 512 to manage these irregularities.

The objective of the parser is to extract the elements of the input language stream that define the application logic, assign appropriate tokens to them (along with values if required) and in the process remove unnecessary elements (included to aid manual reading) such as commas, tabs and white spaces (in the case of a C program for instance).

The parser generates the stream of language interface tokens from the interim token stream from the scanner. The language interface tokens may simply be the interim tokens that were defined as an input to the scanner. However, there are known cases in which the input language symbol stream will generate a set of interim tokens that are not necessarily in the correct order, or the correct tokens. A simple example is the following C++ code segment:

for (int iLoop=0; iLoop <1; iLoop++) {

which could also be written in C or C++ as follows:

int iLoop;
// Other definitions and declarations
....
// start of main code
for (iLoop = 0; iLoop < 1; iLoop++) {

Simply tokenising the input stream could therefore lead to an incorrect output language interface token stream. The parser may therefore be configured to recognise such occurrences and ensure that the generated token sequence is arranged such that a common structure is obtained.

At the output of the parser, therefore, there may be a block (not shown in FIG. 5) that manages the syntax and semantics of the originating language in such a way that the output language interface token stream is correctly represented to both capture the required application logic and format the stream to provide a consistent representation of the given logic. Any of numerous schemes could be selected. The criteria for selection could for example be minimal stream size, most logical structure or possibly one that maximises the speed of implementation of the decoder.

To illustrate the operation of the encoder we will consider a simple, hypothetical example. The example that we will consider is a very simple programming language that supports basic mathematical functions (addition, subtraction, multiplication and division) and also two high level functions (print—to print an output, and while—to implement a simple loop). Although we are only considering these for simplicity, we could of course implement additional functionality (such as conditional statements, branch statements etc.) by extending both the scanner and the parser.

We will start by considering the scanner part first for this simple scheme. Consider the following input file written using the Flex language.

| %{ | |
|---|---|
| #include <stdlib.h> | |
| #include “scriptML.h” | |
| #include “y.tab.h” | |
| void yyerror(char *); | |
| %} | |
| %% | |
| INT | |
| [a-z] | { |

yylval.sIndex = *yytext − ‘a’;
return VAR_TOKEN;

| | |
|---|---|
| | } |
| 0 | { |

yylval.iValue = atoi(yytext);
return INT_TOKEN;

| | |
|---|---|
| | } |
| [1-9][0-9]* | { |

yylval.iValue = atoi(yytext);
return INT_TOKEN;

}

[−( )<>=+*/;{ }.] {

return *yytext;

}

| | |
|---|---|
| “while” | return WHILE_TOKEN; |
| “print” | return PRINT_TOKEN; |
| [ \t\n]+ | ; /* ignore whitespace */ |
| . | yyerror(“Unknown character”); |

%%
int yywrap(void) {

return 1;

}

The essential features of this file are as follows.
Analyse the input symbol stream and identify and respond to the following symbol patterns.
Identify any single character input string and return a numerical value equivalent to its position in the alphabet. Indicate that the token found was of type “VAR_TOKEN” (which will be defined in the parser Bison file below).
Identify any integer string and return its value as well as a token of type “INT_TOKEN”.
Identify a range of characters −( )< >=+*/;{ }. and return their encoded value (ASCII value).
Identify the symbols “while” and “print” and return the tokens “WHILE_TOKEN” and “INT_TOKEN”.
Remove/ignore white space and tab characters.

Flex provides to Bison a stream of data from the scanner. Bison as the parser parses the input stream based on a grammar for the interface language token meta language that is defined in terms of a modified form of BNF.

An example Bison input file for the simple language that we are considering is presented below. The structure for the Bison file consists of the definition of the tokens and their parameters in the upper part, the definition of the grammar in the form of a modified BNF format in the middle, and at the lower part a set of C language routines that construct a “parse tree” from the input stream of tokens and any associated parameters.

%{
#include <stdio.h>
#include <stdlib.h>
#include <stdarg.h>
#include “scriptML.h”
T_node *thisOperator(int ops, int numberOps, ...);
T_node *thisId(int i);
T_node *thisCon(int value);
void freeNode(T_node *n);
int execute(T_node *n);
int yylex(void);
void yyerror(char *s);
int symbol[26];
%}
%union {

int iValue;
char sIndex;
T_node *nPtr;

};
%token <iValue> INT_TOKEN
%token <sIndex> VAR_TOKEN
%token WHILE_TOKEN PRINT_TOKEN
%left ‘>’ ‘<’
%left ‘+’ ‘−’
%left ‘*’ ‘/’
%nonassoc UMINUS
%type <nPtr> stmt expr stmt_list
%%
program:

| | |
|---|---|
| function | { exit(0); } |

;

function:

| | |
|---|---|
| function stmt | { execute($2); freeNode($2); } |

| /* NULL */
;

stmt:

| | |
|---|---|
| ‘;’ | { $$ = thisOperator(‘;’, 2, NULL, NULL); |

}

| | |
|---|---|
| \| expr ‘;’ | { $$ = $1; } |
| \| PRINT_TOKEN expr ‘;’ | { $$ = thisOperator(PRINT_TOKEN, 1, $2); |

}

| | |
|---|---|
| \| VAR_TOKEN ‘=’ expr ‘;’ | { $$ = thisOperator(‘=’, 2, thisId($1), |

$3); }

| WHILE_TOKEN ‘(’ expr ‘)’stmt { $$ = thisOperator(WHILE_TOKEN, 2, $3,

$5); }

| | |
|---|---|
| \| ‘{’ stmt_list ‘}’ | { $$ = $2; } |

;

stmt_list:

| | |
|---|---|
| stmt | { $$ = $1; } |

| | |
|---|---|
| \| stmt_list stmt | { $$ = thisOperator(‘;’, 2, $1, $2); } |

;

expr:

| | |
|---|---|
| INT_TOKEN | { $$ = thisCon($1); } |

| | |
|---|---|
| \| VAR_TOKEN | { $$ = thisId($1); } |
| \| ‘−’ expr %prec UMINUS | { $$ = thisOperator(UMINUS, 1, $2); } |
| \| expr ‘+’ expr | { $$ = thisOperator(‘+’, 2, $1, $3); } |
| \| expr ‘−’ expr | { $$ = thisOperator(‘−’, 2, $1, $3); } |
| \| expr ‘*’ expr | { $$ = thisOperator(‘*’, 2, $1, $3); } |
| \| expr ‘/’ expr | { $$ = thisOperator(‘/’, 2, $1, $3); } |
| \| expr ‘<’ expr | { $$ = thisOperator(‘<’, 2, $1, $3); } |
| \| expr ‘>’ expr | { $$ = thisOperator(‘>’, 2, $1, $3); } |
| \| ‘(’ expr ‘)’ | { $$ = $2; } |

;

%%
T_node *thisCon(int value) {

T_node *n;
/* allocate memory for the node */
if ((n = malloc(sizeof(T_node))) == NULL)

yyerror(“out of memory”);

/* copy information into the node struct */
n−>type = conType;
n−>thisCon.value = value;
return n;

}
T_node *thisId(int i) {

T_node *n;
/* allocate memory for the node */
if ((n = malloc(sizeof(T_node))) == NULL)

yyerror(“out of memory”);

/* copy information into the node struct */
n−>type = idType;
n−>thisId.i = i;
return n;

}
T_node *thisOperator(int ops, int numberOps, ...) {

va_list ap;
T_node *n;
int i;
/* allocate memory for the node */
if ((n = malloc(sizeof(T_node))) == NULL)

yyerror(“out of memory”);

if ((n−>thisOperator.thisOp = malloc(numberOps * sizeof(T_node *))) == NULL)

yyerror(“out of memory”);

/* copy information into the node struct */
n−>type = opType;
n−>thisOperator.ops = ops;
n−>thisOperator.numberOps = numberOps;
va_start(ap, numberOps);
for (i = 0; i < numberOps; i++)

n−>thisOperator.thisOp[i] = va_arg(ap, T_node*);

va_end(ap);
return n;

}
void freeNode(T_node *n) {

int i;
if (!n) return;
if (n−>type == opType) {

for (i = 0; i < n−>thisOperator.numberOps; i++)

freeNode(n−>thisOperator.thisOp[i]);

free (n−>thisOperator.thisOp);

}
free (n);

}
void yyerror(char *s) {

fprintf(stdout, “%s\n”, s);

}
int main(void) {

yyparse( );
return 0;

}

The Bison parser works with the Flex scanner to generate a parse tree. The parse tree then defines the structure of the application logic in terms of the defined tokens (variables, integers, mathematical functions and specific special statements print and while). The parse tree represents the output of the encoder that will be sent to the decoder using the interface language token transport protocol.

To illustrate the operation of the encoder we will consider a simple example. In this example we are entering a simple application logic block using the new simplistic language that we have defined using Flex and Bison. The example application logic block is as follows.

x = 0;
while (x < 7) {

y = 0;
while (y < 5) {

print x;
y = y + 1;

}
x=x+1;

}

This simple example is two loops that will print out the value of an integer x that is in the centre of two while loops. The outer loop increments x by one each iteration, whilst the inner loop increments y by one. The output will print x five times as x counts from 0 to 6. Whilst the language has similarities to C in its structure, the grammar for the language is defined by the Flex and Bison files.

In the examples described above, the originating application is in a single language. However, the use of language interface tokens means that different parts of the originating application could be written in different languages simultaneously. That is, the operation of the encoder with multiple originating languages is not limited to the scope of the complete application logic, i.e. an application written in one language or another language. Within a specific instance of application logic, multiple originating languages can be supported.

The use of these originating languages could be at the level of support libraries, functions or method calls written in different languages, or even multiple applications written in multiple languages to fulfil the requirements of the complete application logic. As the decoder is designed as a super-set of all of the originating languages (with the possible exception of language specific features), the ability to incorporate multiple originating languages into the application logic that is encoded as language interface tokens is a powerful capability offered by the system. The use of a specific language within the scope of e.g. a function can for example be identified by specific tokens in the language interface token stream.

To transport the application logic from the encoder to the decoder, we have a number of options. The parse tree can be used as an input. To illustrate this we can consider the parse tree for the simple application we have just seen. In this simple example, there are two trees within the application. The first corresponds to the first line that initialises x, and the second to the rest of the code that is within the first while loop. The parse trees can be seen in the following two diagrams.

The first tree (reading from left to right) reads id(x)=c(0), or identity x is assigned to the constant 0. The second tree is the first while loop. Inspecting this tree and the source code we can see the origins of the tree are the source code mapped out into the tree.

There are a number of options for transporting the application logic from the decoder to the encoder. These include pseudo code transport and parse tree transport as described below. Pseudo code transport results in a relatively compact representation, but requires a scanner and a parser in the decoder. Parse tree transport is more verbose, but does not require a scanner and parser in the decoder as that has already been done in the encoder since the output (the parse tree) is transported directly.

Pseudo code transport involves converting the parse tree into some form of standardised pseudo code. The pseudo code could look very much like the original source file as it is already in a simple form. Some abbreviations may be employed, for example while and print might be replaced by w and p respectively to economise on space. The use of semi-colons to demarcate the end of a statement could be replaced by a new line character. The use of curly braces to indicate the scope of a function could be replaced with a different character. The exact choice of how this pseudo code is represented is not significant, except that it should aim to minimise the amount of data transmitted.

To decode a transmission in this form at the destination node, a scanner and parser must be implemented to regenerate the parse tree and then process that tree in the decoder accordingly.

Another method of transporting the application logic is to transport (a serialised version of) the parse tree directly. For each tree, the parse tree is made of a starting node, followed by a number of child nodes. (Note that “node” in reference to a parse tree does not imply the physical node described above, e.g. in relation to FIG. 2.) As the tree is walked from the top down and from left to right the tree structure is encoded by using additional language interface tokens to identify the location of a specific language interface token within the tree. As an example consider the following additional language interface tokens.
Tn—used to identify the start of tree n.
Cyx—used to identify a child node of the tree where y is the depth of the child node (how far down the tree—y axis) and x is the number of the child node below the parent node (the x axis for a given y). In practice when we parse the tree, we can arrange for there to be at most two child node per parent, so in many cases we can omit x and just use multiple copies of Cy to indicate the child node, assume that we are parsing from left to right and characterise the tree in that manner.
Ln—used to identify a leaf node of the tree, where the leaf node is the end of part of the tree often referred to as the terminal node. A leaf node indicates that there is nothing else below this language interface token on the tree and it is a terminal node. Where n defines the left to right location (0,1,2) but in general we can keep the number of leaf nodes to two, in which case we could omit n and just use L twice and the meaning will be clear.

We can formulate a mechanism for conveying the parse tree using a simple encoding scheme (as an example). The encoding scheme could be in the form of a doublet such as {<tree_level_location><token_identity_or_literal>}. This doublet could be repeated for each node and leaf in the tree. It should be appreciated that this coding scheme is very literal, and more compact and efficient encoding schemes can be devised that utilise the well-defined structure and repetition that is likely in a parse tree of this kind. For the example above we would have something like:

T1=L0id(X)L1c(0)

T2 while C0<L0 id(X) L1 c(7) C0; C1; C2=L0 id(Y) L1 c(0) C2 while C3<L0 id(Y) L1 c(5) C3; C4 print L0 id(X) C4=L0 id(Y) C4+L0 id(Y) L1 c(1) C1=L0 id(X) C2+L0 id(X) L1 c(1)

Here we use the case in which we are ignoring x for the Cyx child node representation. The different node identifiers and language interface tokens can be encoded using a simple 8 bit or 16 bit representation with either a fixed or dynamic mapping scheme. This encoding scheme relies on the assumption that we traverse down the tree taking the left most path each time, then reverse up and take the next left most path that has not been taken.

FIGS. 6A and 6B illustrate two alternative example implementations for decoding and executing the language interface tokens at the destination node. In both cases the decoder 620 takes language interface tokens received at a receiver of the destination node as input to a decoded parse tree builder 610 whose output is a decoded parse tree. Example operation of such a decoded parse tree builder is described below in relation to FIG. 6C.

In the example of FIG. 6A, the decoded parse tree is output to a translator 613 which outputs script in the destination language to a compiler 614. (While translator 613 functions in a similar manner to known code translators, as explained above the operation it performs is not strictly speaking translation, since the language interface tokens are not elements of a language as such.) Compiler 614 then passes a block of application logic in the destination language to destination application 630 to execute. If accelerator functions are used, the relevant hardware and/or software accelerator library functions are also input to destination application 630.

In the example of FIG. 6B, the decoded parse tree is input to an interpreter 631 in the destination application 630, optionally together with hardware/software accelerator library functions. The interpreter walks the parse tree to execute the desired application logic, communicating with hardware interface 632 as necessary. This option requires less processing power at the destination node than the example of FIG. 6A.

In both the decoding methods of FIGS. 6A and 6B, the same decoded parse tree builder can be used. If parse tree transport is used, this simply reconstructs the parse tree serialised in the received transport packets. If pseudo code transport is used however, decoded parse tree builder 610 functions as illustrated in FIG. 6C. This essentially performs the reverse operation of the encoder. It comprises a scanner 611 and a parser 612. The scanner and parser could be implemented using Flex and Bison respectively, in a similar manner to those of encoder 510. The scanner 611 takes a stream of language interface tokens as input, then uses common interim token definitions, and optionally destination language specific interim token definitions, to identify and tag the language interface tokens and output a stream of interim tokens and literals to the parser 612. The parser 612 then uses common grammar definitions, and optionally destination language specific grammar definitions, to output the decoded parse tree.

The originating node could store certain capability data relating to the destination nodes it communicates with. This could for example be in the form of an extensible markup language (XML) document. It could relate to information such as product identity, manufacturer, software version, hardware version etc.

As one example, if any accelerator functionality is provided at a destination node as described above, the originating node could store data on this to enable it to determine whether certain functions/procedures can be understood by the destination node without translation and, if so, whether it would therefore be most efficient to copy the application logic into the transmission as is and flag it as needing to be handled by the accelerator.

Capability data could include data on other hardware and software capabilities of the destination nodes, for example the size of their memories (read-only memory, ROM and random-access memory, RAM), clock speed, whether they are capable of sensing certain physical conditions or acting on certain instructions on request, depth of recursion supported for flow control statements, stack limits, data types supports, array sizes, string lengths etc.

Such capability data could be stored in detail, or destination nodes could be assigned a class according to their capabilities and the originating node could simply store the class of each destination node.

Capability data could be exchanged as part of a registration process when a network is established or when a new node is added to an existing network. Alternatively, it could be exchanged in an ad hoc manner whenever needed.

It is envisaged that the methods described herein will be useful where initialisation and/or control and/or monitoring of spoke nodes by a hub node is desired. This will often require addressing interfaces, so the capability data might usefully define available interfaces and associated parameters. For example, types of interfaces could include I²C, SPI, RS232, GPIO—which may also include variants that are defined to support functions such as pulse-width modulation (PWM), analogue input interfaces from analogue to digital converters (ADCs), analogue output interfaces from digital to analogue converters (DACs), camera serial interfaces (CSIs) and USB interfaces. Interface-related capability data could for example include port names and number associated with a specific interface, the interface type and parameters of the interface such as number of connections, sample rates and protocol variants.

Destination nodes may not have XML encoding capability, so if an XML schema is used to define their capabilities it can be hardcoded and stored in read-only memory (ROM) for each version of the software/firmware that the node supports. The destination node can then pass this hardcoded data to the originating node which can interpret the XML according to a predefined schema.

As described above, the transmitted language interface tokens can comprise a serialised encoding of a parse tree, or pseudo code. In addition, the language interface tokens can represent additional logic that may or may not be derived directly from the parsing process. This additional information can include special language features, decoder capability requirements, language extensions and any other additional information that may be used to simplify either the encoding or the decoding process.

According to one proposed example language interface token encoding scheme, known as Script Meta Language (ScriptML), the base capabilities supported include:
simple variables of integer and floating point type;
flow control statements based on IF-THEN-ELSE clauses, with the support for recursive nesting if required up to some pre-defined depth;
simple loops (similar to a C while loop), with the support for recursive nesting if required up to some pre-defined depth;
case and Switch statements similar to those supported in C, with the support for recursive nesting if required up to some pre-defined depth;
accelerator functions, with the accelerators defined in the destination node in some native format (which could be C or assembler for instance), but called directly via the ScriptML protocol—the accelerator functions can be either hardware accelerators or software accelerators;
Get and Set primitives that allow the ScriptML protocol to directly access the input/output (IO) interface ports, with the capability information of the destination node defining the type of IO interface and the nature of the data that is being managed;
simple Math functions that allow for basic Math operations (plus, minus, multiply, divide, square root, square) and arithmetic test functions (greater than/equal to, less than/equal to, not equal, equal), but for more complex devices may also include complex Math functions such as generic trigonometric functions—the support for the type of Math functions can be defined by the destination node capability based on an XML schema defined within the ScriptML protocol; and
timer and wait functions that allow the ScriptML protocol to tell the destination node to wait for some defined period before proceeding to the next part of the script.

A range of variable types may be supported, for example 32 bit integers, 32 bit floats and Boolean.

According to the ScriptML XML schema, capability data can include:
central processing unit (CPU) type, e.g. 8 bit microchip/32 bit cortex;
RAM size;
ROM size;
stack limits;
details of software interrupts supported (e.g. number, type and priority)
details of hardware interfaces supported (e.g. number and type)
details of hardware and software accelerators supported
recursion depth for loops;
nesting limits for IF-ELSE;
nesting level of case statements;
maximum number of variables supported;
whether 4 byte integers (signed or unsigned) are supported;
whether 4 byte floating point numbers are supported;
whether strings are supported;
maximum string length;
whether one-dimensional (1D) arrays are supported;
maximum array length; and
level of math function support, e.g. no support, basic support, advanced support (e.g. including trigonometric functions).

The transport protocol used to transmit language interface tokens could for example be a request-response protocol in which transport packets are sent by the originating node and acknowledged by the destination node, for example using positive acknowledgement messages (ACKs) or negative acknowledgement messages (NACKs) as appropriate, as discussed below. All of these messages can optionally be sent via one or more relay nodes. The originating node can send packets continuously and the destination node can respond to the packets as they arrive.

FIG. 7 illustrates an example message flow such as might occur between originating node (ON) 310 and destination node (DN) 320. At 701 a first transport packet (TP1) is transmitted from the ON to the DN. TP1 is acknowledged by the DN by transmitting ACK1 to the ON at 702.

At 703 and 704 respectively, second and third transport packets (TP2 and TP3) are transmitted from the ON to the DN. Though the DN will generally be configured to acknowledge transport packets as soon as possible after receipt, it will take some time to verify that the packet has been received fully and correctly. Therefore, if TP3 is transmitted very soon after TP2 the acknowledgement of TP2 (ACK2) might not be transmitted from the DN to the ON until after TP3 has been received. In the example shown, ACK3 is therefore transmitted at 706, directly after ACK2 at 705.

At 707 the ON attempts to transmit another transport packet (TP4) to the DN. However, transmission is disrupted, for example due to interference, and TP4 is not received at the DN. At 708 a timer at the DN set to expire when there has been no communication from the ON for a predetermined period runs out. The DN therefore sends a negative acknowledgement (NACK4) to the ON to indicate that TP4 has been lost at 709. This allows the ON to determine whether retransmission of TP4 is appropriate, or whether the communication session should be ended, e.g. due to adverse channel conditions.

FIG. 8A illustrates the structure of an example transport packet 800 comprising a header 820 and a payload 830.

The main content of each message is the script; the language interface tokens encoded e.g. as pseudo code or as a parse tree as described above. This is preceded by a token table which defines what tokens are used in the script and what numeric value they are assigned. These numeric values are used when decoding the script. The token table and script are preceded by a number of header fields. If the message cannot fit into a single packet like the example packet 800 then the token table and/or script may be spread over several packets.

The first header field 801 (VERS) indicates the protocol version number. This field could for example be 4 bits long.

The second header field 802 (OLANG) indicates the originating language. This field could for example be 8 bits long, e.g. split into a 5 bit sub-field identifying the originating language and a 3 bit sub-field indicating the version of encoder used at the originating node. Languages for the originating language sub-field could for example be identified as follows.

| Dec | Binary | Language |
|---|---|---|
| 0 | 00000 | RESERVED, |
| 1 | 00001 | Ada, |
| 2 | 00010 | BASIC, |
| 3 | 00011 | C, |
| 4 | 00100 | C++, |
| 5 | 00101 | C#, |
| 6 | 00110 | Fortran, |
| 7 | 00111 | Go, |
| 8 | 01000 | Haskell, |
| 9 | 01001 | Java, |
| 10 | 01010 | JavaScript, |
| 11 | 01011 | LabVIEW, |
| 12 | 01100 | Mathematica, |
| 13 | 01101 | Matlab, |
| 14 | 01110 | Objective-C, |
| 15 | 01111 | Octave, |
| 16 | 10000 | Pascal, |
| 17 | 10001 | Pearl, |
| 18 | 10010 | PHP, |
| 19 | 10011 | Python, |
| 20 | 10100 | Ruby, |
| 21 | 10101 | Tcl, |
| 22 | 10110 | Visual Basic |
| . . . | | |
| 31 | 11111 | RESERVED |

The third header field 803 (DLANG) indicates the destination language. This field could for example be 4 bits long, e.g. with languages identified as follows.

| Dec | Binary | Language |
|---|---|---|
| 0 | 0000 | RESERVED |
| 1 | 0001 | Assembler language |
| 2 | 0010 | C |
| 3 | 0011 | C++ |
| 4 | 0100 | Python |
| . . . | | |
| 15 | 1111 | RESERVED |

Other languages could of course be supported as one or more of originating and destination languages, the above are just a selection of those anticipated to be most commonly used.

The fourth header field 804 (CAPAB) indicates the destination node capability class. This field could for example be 8 bits long.

The fifth header field 805 (FMT) indicates the format type used for the encoding, e.g. compressed pseudo code or parse tree as described above. This field could for example be 8 bits long.

The sixth header field 806 (MSG LTH) indicates the total length of the message, e.g. in pages where each page corresponds to a single transport packet. This field could for example be 8 bits long (provided the maximum number of pages in less than 255).

The seventh header field 807 (PKT NO.) indicates the packet number, e.g. to allow for detection of missing or duplicate packets. This field could for example be 8 bits long. The packet number increments for each transmitted packet. The numbering could re-start for each new message.

The eighth header field 808 (TOK TBL LTH) indicates the length of the token table, e.g. in terms of number of tokens transported. This field could for example be 16 bits long.

The ninth header field 809 (TOK TBL TYP) indicates the token table type, i.e. the encoding scheme used to encode the tokens in the table. This field could for example be 8 bits long.

The tenth header field 810 (SPT ID) is the script identity field. This field could for example be 24 bits long. It could for example contain a hash function of the entire script, allowing the decoder to validate that a complete script has been received without error.

The first payload field 811 (TOK TBL) is the token table. The length of this field depends on the number of tokens and the format used for the token encoding.

The second payload field 812 (TOK TBL END) is a unique identifier used to mark the end of a token table. This field could for example be 16 bits long. If the token table is sent in more than a single transport packet, the end of token table marker is only sent in the transport packet in which the token table ends (immediately after the end of the token table). The format for the end of token table marker is selected to prevent the token table from erroneously being indicated as complete, e.g. binary 1111111111111110 could be reserved for this purpose. If there is not any token table present—i.e. in later packets of a multi-packet message—this could be indicated in the TOK TBL TYP field, or the TOK TBL END field could be used to indicate that there are no tokens in this or subsequent packets.

The third payload field 813 (SPT START) is a unique identifier used to mark the start of a script. This field could for example be 16 bits long. If the script is sent in more than a single transport packet, the start of script marker is only sent in the transport packet in which the script starts (immediately before the start of the script). The format for the start of script marker is selected to prevent the script from erroneously being indicated as commencing, e.g. binary 1111111111111101 could be reserved for this purpose.

If the script is spread over multiple packets, fields 811 to 813 could be replaced by a CONT SPT field to indicate the continuation of script from a previous packet.

The fourth payload field 814 (SPT) is the script. The length of this field depends on the transport packet length and the format type selected.

The fifth payload field 815 (SPT END) is a unique identifier used to mark the end of a script. This field could for example be 16 bits long. If the script is sent in more than a single transport packet, the end of script marker is only sent in the transport packet in which the script ends (immediately after the end of the script). The format for the end of script marker is selected to prevent the script from erroneously being indicated as complete, e.g. binary 1111111111111100 could be reserved for this purpose.

FIG. 8B illustrates the structure of an example ACK/NACK packet 850.

The first field 851 (VERS) indicates the protocol version number. This field could for example be 4 bits long.

The second field 864 (ACK/NACK) is the substantive part of the ACK/NACK packet. This field could for example be 8 bits long. It could for example be split into an initial 1 bit sub-field to indicate whether the packet is an ACK or a NACK, followed by a 7 bit sub-field to provide detail on this, e.g. codes could be used as follows.

| Dec | Binary | Description |
|---|---|---|
| 0 | 000000 | SUCCESS - used for ACK only |
| 1 | 000001 | CORRUPT packet |
| 2 | 000010 | MISSING packet |
| 3 | 000011 | RESTART request |
| . . . | | |
| 127 | 111111 | RESERVED |

The third field 857 (PKT NO.) indicates the packet number the ACK/NACK is for. This field could for example be 8 bits long. The numbering could re-start for each new message.

The fourth field 860 (SPT ID) is the script identity field. This contains the SPT ID of the packet the ACK/NACK is for. This enables the originating node to identify which packet the ACK/NACK is for in the case that multiple messages have been sent within a short timeframe. This field could for example be 24 bits long, per field 810.

As has been described above, the use of language interface tokens can improve device interoperability. Without the use of language interface tokens as described above, a system that sends code to a receiving node for execution of application logic written on an originating node would require the destination node to comprise a decoder to support each of the source languages that may be used in the originating node. Each of these decoders (for example for Java, C and Python) would require additional memory (both ROM and RAM). In addition, it is likely that the processor of the destination node would be required to operate at a faster clock speed to meet target timing requirements. With the use of language interface tokens, however, a single decoder is used to support all languages, reducing the complexity required of the destination node decoder. This means that the destination node need only be equipped with e.g. a small microcontroller, as opposed to a fast CPU.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

Receivers and transmitters as described herein may be standalone or may be comprised in transceivers. User input devices can include, without limitation, microphones, buttons, keypads, touchscreens, touchpads, trackballs, joysticks and mice. User output devices can include, without limitation, speakers, graphical user interfaces, indicator lights and refreshable braille displays. User interface devices can comprise one or more user input devices, one or more user output devices, or both.

1. A method of communicating between an originating application running on an originating node and a destination application running on a destination node, wherein an originating language of application logic of the originating application is different from a destination language of application logic of the destination application, the method comprising:
encoding, by the originating node, a block of application logic of the originating application into one or more language interface tokens to be transmitted to the destination node,
wherein the language interface tokens are configured to be decoded by the destination node for execution by the destination application.

2. The method of claim 1, further comprising:
transmitting, by the originating node, the language interface tokens to the destination node.

3. The method of claim 1, further comprising:
decoding the language interface tokens by a decoder at the destination node.

4. The method of claim 2, further comprising:
executing the destination application using the language interface tokens to provide an output of a decoder.

5. The method of claim 1, wherein the encoding comprises:
converting, by a scanner, the block of application logic of the originating application into one or more interim tokens and/or literals;
passing the one or more interim tokens and/or literals to a parser; and
converting, by the parser, the one or more tokens and/or literals into the one or more language interface tokens.

6. The method of claim 5, wherein a set of interim tokens common to all supported originating languages and a set of language specific interim tokens, specific to the language of the originating application, are input to the scanner, and/or grammar common to all supported originating languages and language specific grammar, specific to the language of the originating application, are input to the parser.

7. The method of claim 1, further comprising: preparing, by the originating node, the language interface tokens for transport in the form of a serialized parse tree, or as a pseudo code representation of a parse tree from which the parse tree can be reconstructed.

8. The method of claim 7, wherein in addition to the serialized parse tree or the pseudo code representation of the parse tree, the language interface tokens comprise additional logic not derived directly from parsing.

9. The method of claim 8, wherein the additional logic comprises one or more of special language features, decoder capability requirements, or language extensions.

10. The method of claim 2, further comprising:
transmitting the language interface tokens to the destination node via a relay node.

11. The method of claim 1, wherein the encoding comprises:
encoding, by the originating node, address data comprising identification data for the destination node, and/or data identifying a location of the destination node.

12. The method of claim 11, further comprising:
encoding, by the originating node, an additional block of application logic of the originating application into one or more additional language interface tokens to be transmitted to an additional node, wherein the additional language interface tokens are configured to be decoded by the additional node and executed by an additional application running on the additional node according to application logic in an additional language,
wherein the encoding of the additional block of application logic comprises encoding of address data for the additional node.

13. The method of claim 1, wherein the block of application logic of the originating application is configured to perform one or more of initializing, controlling, or monitoring of the destination node.

14. The method of claim 1, further comprising: storing, by the originating node, capability data relating to the destination node.

15. The method of claim 14, wherein the encoding comprises:
determining, using the capability data, that the block of application logic of the originating application comprises a function or a procedure supported by an accelerator of the destination node; and
encoding the function or the procedure by copying an expression associated with the function or the procedure in the originating language and adding an accelerator flag to indicate to the destination node that the function should be executed directly by the accelerator, without decoding.

16. The method of claim 1, wherein the encoding comprises:
defining additional language interface tokens; and
encoding the additional language interface tokens together with an extension token flag.

17. The method of claim 1,
wherein application logic of the originating application is in a plurality of originating languages,
wherein the block of application logic comprises a plurality of functions, support libraries, and/or method calls respectively coded in a plurality of the plurality of originating languages.

18. An originating node comprising:
memory configured to store application logic for an originating application in an originating language; and
a processor configured to encode a block of the application logic in the originating language into one or more language interface tokens to be transmitted to a destination node,
wherein the language interface tokens are configured to be decoded for execution by an application running on the destination node according to application logic in a destination language.

19. A method of communicating between an originating application running on an originating node and a destination application running on a destination node, wherein the originating application comprises an originating language, wherein the destination application comprises a destination language that is different from the origination language, the method comprising:
receiving one or more language interface tokens that were encoded by the originating node by a block of application logic in the originating language; and
decoding, by the destination node, the one or more language interface tokens for execution by the destination application.

20. The method of claim 19, wherein the decoding comprises:
converting a received serialized parse tree comprising the one or more language interface tokens into a decoded parse tree.

21. The method of claim 20, wherein the decoding further comprises:
converting, by a scanner, received pseudo code comprising the one or more language interface tokens into one or more interim tokens and/or literals;
passing the one or more interim tokens and/or literals to a parser; and
converting, by the parser, the one or more interim tokens and/or literals into a decoded parse tree.

22. The method of claim 21, wherein a set of interim tokens common to all supported destination languages and a set of language specific interim tokens, specific to the destination language of the destination application, are input to the scanner, and/or grammar common to all supported destination languages and language specific grammar, specific to the destination language of the destination application, are input to the parser.

23. The method of claim 20, wherein the decoding comprises:
inputting the decoded parse tree to a translator; and
inputting an output of the translator to a compiler.

24. The method of claim 20, further comprising:
passing the decoded parse tree to an interpreter of the destination application for execution.

25. A destination node comprising:
memory configured to store application logic for a destination application in a destination language; and
a processor configured to decode one or more language interface tokens for execution by the destination application, the language interface tokens having been received from an originating node which encoded the language interface tokens from a block of application logic of an originating application in an originating language which differs from the destination language.

26. A method of communicating between an originating application running on an originating node and a destination application running on a destination node, wherein application logic of the originating and destination applications is respectively in differing originating and destination languages, the method comprising:
encoding, by the originating node, a block of application logic of the originating application into one or more language interface tokens;
transmitting, by the originating node, the language interface tokens to the destination node;
receiving, by the destination node, the language interface tokens;
decoding, by the destination node, the language interface tokens for execution by the destination application; and
executing, by the destination application, the decoded language interface tokens.

27. A communication system comprising an originating node and a destination node, wherein the originating node comprises:
memory configured to store application logic for an originating application in an originating language; and
a first processor configured to encode a block of the application logic in the originating language into one or more language interface tokens to be transmitted to the destination node; and
wherein the destination node comprises:
memory configured to store application logic for a destination application in a destination language; and
a second processor configured to decode the language interface tokens for execution by the destination application.

28. The communication system of claim 27, further comprising:
a relay node configured to route language interface tokens received from the originating node to the destination node.

29.-36. (canceled)
